(19) United States
(12) Patent Application Publication
(10) Pub. No.: US 2026/0017188 A1
(43) Pub. Date: Jan. 15, 2026

(54) ELECTRONIC DEVICE, ELECTRONIC SYSTEM INCLUDING THE SAME, AND OPERATING METHOD OF THEREOF

(71) Applicant: Samsung Electronics Co., Ltd., Suwon-si (KR)

(72) Inventor: Min SOHN, Suwon-si (KR)

(21) Appl. No.: 19/009,646

(22) Filed: Jan. 3, 2025

(30) Foreign Application Priority Data
Jul. 11, 2024 (KR) 10-2024-0092026
Aug. 22, 2024 (KR) 10-2024-0112798

(51) Int. Cl. G06F 12/02; G06F 1/26

(52) U.S. Cl. CPC G06F 12/0246; G06F 1/263; G06F 2212/1028; G06F 2212/7205

(57) ABSTRACT

An electronic device of communicating with a storage device comprising a volatile memory and a nonvolatile memory includes a monitoring circuit configured to identify state information of the electronic device while data is stored in the volatile memory, and an operation controller configured to transmit to the storage device a flush command instructing to perform a flush operation by which the data stored in the volatile memory is stored in the nonvolatile memory based on the state information of the electronic device.

### CROSS-REFERENCE TO RELATED APPLICATION(S)

This application claims the benefit of Korean Patent Application No. 10-2024-0092026, filed on Jul. 11, 2024, and Korean Patent Application No. 10-2024-0112798, filed on Aug. 22, 2024, in the Korean Intellectual Property Office, the disclosures of each of which is incorporated herein their entireties by reference.

### BACKGROUND

### 1. Field of the Invention

Example embodiments relate to an electronic device that communicates with a storage device, an electronic system including the same and a method of operating the same.

### 2. Description of the Related Art

An electronic device can communicate with a storage device to store data or to read stored data. The storage device is a device that can store data. The storage device can be powered by an electronic device. Meanwhile, if the power inside the electronic device is unstable or the storage device is separated from the electronic device, there is a possibility that data may be lost if power supplied to the storage device is cut off, and thus methods to prevent this are required.

### SUMMARY

An aspect provides an electronic device by which data loss is minimized, an electronic system including the same, and a method of operating the same.

The technical tasks to be achieved by the present example embodiments are not limited to the technical tasks described above, and other technical tasks may be inferred from the following example embodiments.

According to an aspect of the present disclosure, an electronic device of communicating with a storage device comprising a volatile memory and a nonvolatile memory includes a monitoring circuit configured to identify state information of the electronic device while data is stored in the volatile memory, and an operation controller configured to transmit to the storage device a flush command instructing to perform a flush operation by which the data stored in the volatile memory is stored in the nonvolatile memory based on the state information of the electronic device.

According to an aspect of the present disclosure, a method of operating an electronic device that communicates with a storage device comprising a volatile memory and a nonvolatile memory includes identifying state information of the electronic device while data is stored in the volatile memory, and transmitting to the storage device a flush command instructing to perform a flush operation by which the data stored in the volatile memory is stored in the nonvolatile memory based on the state information of the electronic device.

According to an aspect of the present disclosure, an electronic system includes a storage device comprising a volatile memory, a nonvolatile memory, and a memory interface, and an electronic device that comprises an interface configured to communicate with the memory interface, and a flush controller configured to identify state information of the electronic device while data is stored in the volatile memory, and based on the state information, transmit a flush command to the storage device through the interface. The storage device further comprises a memory controller configured to perform a flush operation by which the data stored in the volatile memory is stored in the nonvolatile memory in response to the flush command received through the memory interface.

Additional aspects of example embodiments will be set forth in part in the description which follows and, in part, will be apparent from the description, or may be learned by practice of the disclosure.

According to example embodiments, it is possible to provide an electronic device by which data loss is minimized, an electronic system including the same, and a method of operating the same.

According to example embodiments, it is possible to provide an electronic device by which data reliability is improved, an electronic system including the same, and a method of operating the same.

Effects of the present disclosure are not limited to those described above, and other effects may be made apparent to those skilled in the art from the following description.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a block diagram illustrating an electronic device and an electronic system according to an example embodiment;

FIG. 2 is a block diagram illustrating an electronic device and an electronic system according to an example embodiment;

FIG. 3 is a drawing for explaining an electronic device according to an example embodiment;

FIG. 4 is a drawing for explaining state information according to an example embodiment;

FIG. 5 is a drawing for explaining a backup power supply unit according to an example embodiment;

FIG. 6A is a diagram illustrating a flush controller, a processor, and an interface according to an example embodiment;

FIG. 6B and FIG. 6C are drawings for explaining a switch according to an example embodiment;

FIG. 7 is a drawing for explaining a storage device according to an example embodiment;

FIG. 8 is a flowchart for explaining a method of operating an electronic device according to an example embodiment;

FIG. 9 is a drawing specifically explaining a method of operating an electronic device according to a state value included in state information;

FIG. 10 is a drawing specifically explaining a method of operating an electronic device according to the remaining life included in state information;

FIG. 11 is a drawing specifically explaining a method of operating an electronic device according to a temperature value included in state information;

FIG. 12 is a drawing specifically explaining a method of operating an electronic device according to a state of a latch included in state information; and

FIGS. 13A to 13D are drawings for explaining an electronic device according to an example embodiment.

### DETAILED DESCRIPTION

Terms used in the example embodiments are selected from currently widely used general terms when possible while considering the functions in the present disclosure. However, the terms may vary depending on the intention or precedent of a person skilled in the art, the emergence of new technology, and the like. Further, in certain cases, there are also terms arbitrarily selected by the applicant, and in the cases, the meaning will be described in detail in the corresponding descriptions. Therefore, the terms used in the present disclosure should be defined based on the meaning of the terms and the contents of the present disclosure, rather than the simple names of the terms.

Throughout the specification, when a part is described as “comprising or including” a component, it does not exclude another component but may further include another component unless otherwise stated. Furthermore, terms such as “ . . . unit,” “ . . . group,” and “ . . . module” described in the specification mean a unit that processes at least one function or operation, which may be implemented as hardware, software, or a combination thereof.

Hereinafter, example embodiments of the present disclosure will be described in detail with reference to the accompanying drawings so that those of ordinary skill in the art to which the present disclosure pertains may easily implement them. However, the present disclosure may be implemented in multiple different forms and is not limited to the example embodiments described herein.

Hereinafter, example embodiments will be described in detail with reference to the drawings.

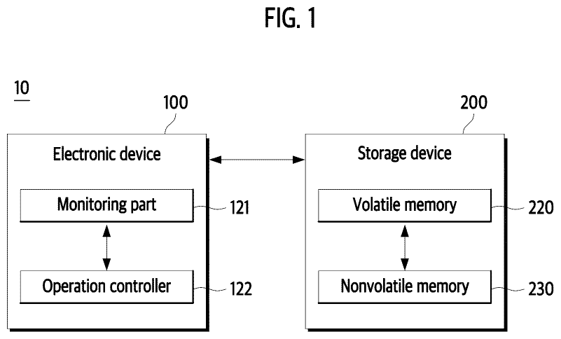

FIG. 1 is a block diagram illustrating an electronic device and an electronic system according to an example embodiment.

Referring to FIG. 1, an electronic system 10 according to the embodiment of the present disclosure may include an electronic device 100 and a storage device 200.

In an example embodiment, the electronic device 100 may be a server. However, it is a mere example embodiment. The electronic device 100 may be implemented with various types of electronic devices such as desktop computer, laptop computer, smartphone, tablet, navigation, vehicle infotainment system, digital camera, smartwatch, smart-glass, augmented reality device, mixed reality device, virtual reality device, game console, smart speaker, robot, industrial equipment, smart TV, wireless router, Internet of Things (IoT) device and so on.

In an example embodiment, the storage device 200 may be a solid state drive (SSD). For example, SSDs may be implemented in various forms such as non-volatile memory express (NVMe) SSD, serial advanced technology attachment (SATA) SSD, M.2 SSD, U.2 SSD, and enterprise SSD. However, those are mere example embodiments, and in addition to the SSDs, the storage device 200 may be implemented as various types of storage device such as non-volatile dual in-line memory module (NVDIMM), storage class memory (SCM), and solid state hybrid drive (SSHD).

The storage device 200 may include volatile memory 220 and nonvolatile memory 230. The volatile memory 220 may retain data stored while power supply is maintained. The nonvolatile memory 230 may retain stored data even when power is cut off. In an example embodiment, the storage device 200 may include one or more volatile memories 220 and one or more nonvolatile memories 230.

In an example embodiment, the volatile memory 220 may include at least one of dynamic random access memory (DRAM) and static random access memory (SRAM). The DRAM may store data through the charge state of a capacitor. The SRAM may store and retain data through a feedback loop or a cross-coupled latch circuit.

In an example embodiment, the nonvolatile memory 230 may contain at least one of NAND flash memory, NOR flash memory, ferroelectric random access memory (FRAM), phase-change random access memory (PCRAM), magnetic random access memory (MRAM), and hard disk drive (HDD). The NAND flash memory may include multiple floating gate transistors connected in series. A floating gate transistor may include a control gate, a floating gate, and a channel. When operating voltage is applied to the control gate, the floating gate transistor may store data by using the principle that the current flow in the channel changes depending on the electrons accumulated in the floating gate. The NOR flash memory may contain multiple floating gate transistors connected in parallel. The FRAM may store data through the polarization state of a ferroelectric material. The PCRAM may store data through the state of the phase change material (for example, amorphous state or crystalline state). The MRAM may store data by changing the magnetization direction of the magnetic layer. The HDDs may store data magnetically using magnetic recording heads on rotating platters.

The electronic device 100 and the storage device 200 may communicate with each other. For example, the electronic device 100 and the storage device 200 may transmit and receive requests or data. In an example embodiment, the electronic device 100 may transmit commands instructing operations to the storage device 200, and the storage device 200 may perform operations corresponding to the commands. For example, the electronic device 100 may transmit program commands and data to the storage device 200, and the storage device 200 may store data when program commands and data are received. For example, the electronic device 100 may transmit a read command to the storage device 200, and the storage device 200 may output stored data when the read command is received.

In an example embodiment, the storage device 200 may temporarily store data in the volatile memory 220. The storage device 200 may perform a flush operation. The flush operation may be saving data temporarily stored in the volatile memory 220 in the nonvolatile memory 230. For example, in the flush operation, the data stored in the volatile memory 220 may be stored or moved in the nonvolatile memory 230 in the case the loss of power supplied to the volatile memory 220 happens or in the case the power supply to the volatile memory device 220 is unstable. Such power loss or unstable power may cause the loss of the data stored in the volatile memory device 220. With the flush operation, the data stored in the volatile memory device 220, in the case of the power loss or the unstable power supply occurring, may be moved to the nonvolatile memory device 230 which does not lose data even when the power supplied to the storage device 200 is cut off. In an example embodiment, the storage speed of the volatile memory 220 may be faster than that of the nonvolatile memory 230. According to some example embodiments, based on the difference in storage speed, priorities may be set for the areas where data is stored. In other words, data may be stored by prioritizing areas with fast storage speeds, and data may be stored by prioritizing areas with slow storage speeds. Accordingly, data storage efficiency may be improved.

The electronic device 100 may include a monitoring part 121 (i.e., a monitoring circuit) and an operation controller 122.

The monitoring part 121 may identify the state information of the electronic device 100. The operation controller 122 may transmit a flush command to the storage device 200 based on the state information of the electronic device 100. The flush command may be a command that instructs to perform the flush operation by which the data stored in the volatile memory 220 is stored in the nonvolatile memory 230. The state information may include at least one of various information, such as state values and temperature values, which represent the states inside the electronic device 100.

In an example embodiment, the monitoring part 121 may identify state information. The monitoring part 121 may output a trigger signal based on a result of identifying the state information. For example, the monitoring part 121 may identify whether state information satisfies the trigger conditions, and when the state information meets the trigger condition, the monitoring part 121 may output a trigger signal to the operation controller 122. In an example embodiment, the monitoring part 121 may periodically obtain state information while data is stored in the volatile memory 220. For example, the time point at which the monitoring part 121 identifies the state information may be the time point after the time point at which data storage in the volatile memory 220 is completed, and may be the time point at which the volatile memory 220 maintains the stored data.

In an example embodiment, the monitoring part 121 may receive digital signals (for example, values or commands) and obtain the digital signals as state information. In another example embodiment, the monitoring part 121 may include an analog-to-digital converter (ADC). In this case, the monitoring part 121 may receive analog signals (for example, voltage) and convert the analog signals into digital signals to obtain the state information. In a specific example embodiment, the monitoring part 121 may convert an analog signal into a digital signal with a value corresponding to the level of the analog signal, or to a digital signal that has a specific state (for example, 0 or 1) depending on whether the level of the analog signal is greater or less than the level of a reference signal. In an example embodiment, the monitoring part 121 may obtain state information of the electronic device 100 through various communication interfaces such as general-purpose input/output (GPIO), inter-integrated circuit (I2C), improved inter-integrated circuit (13C) and system management bus (SMBus). The monitoring part 121 may output to the operation controller 122 a trigger signal based on the state value (or the temperature value) included in the state information. When receiving the trigger signal, the operation controller 122 may transmit a flush command may be transmitted to the storage device 200.

Meanwhile, when the power supplied to the storage device 200 is cut off, the data stored in the volatile memory 220 may be lost. In other words, when the data is temporarily stored only in the volatile memory 220 and the data is not stored in the nonvolatile memory 230, if power to the storage device 200 is cut off, the data may be lost. According to example embodiments of the present disclosure, by identifying the state information inside the electronic device 100, the electronic device 100 may control the storage device 200 to perform a flush operation before power is cut off. According to example embodiments of the present disclosure, provided are the electronic device 100 that minimizes the data loss, the electronic system 10 including the same, and a method of operating the same. Further, the data processing efficiency and data reliability may be improved together. Hereinafter, embodiments of the present disclosure will be described in more detail.

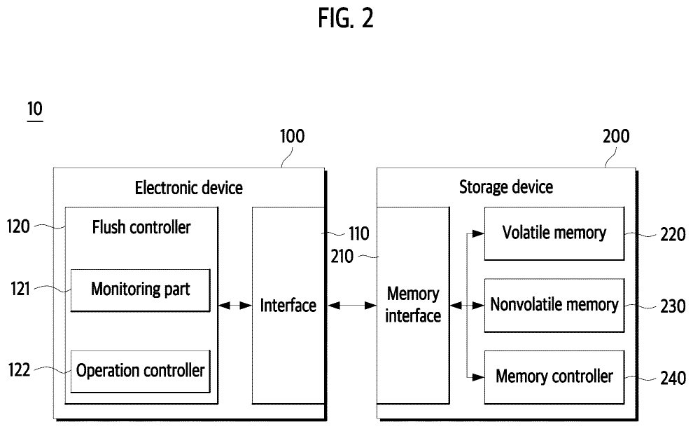

FIG. 2 is a block diagram illustrating an electronic device and an electronic system according to an example embodiment.

Referring to FIG. 2, the electronic system 10 may include the electronic device 100 and at least one storage device 200. The number of storage device 200 may be one or more.

The electronic device 100 may include an interface 110 and a flush controller 120.

The interface 110 may communicate with a memory interface 210 of the storage device 200. In an example embodiment, the interface 110 and the memory interface 210 may be connected to each other through slots and connectors. In an example embodiment, when a flush command is received from the flush controller 120 or when a control command instructing to transmit a flush command is received from the flush controller 120, the interface 110 may transmit the flush command to the memory interface 210.

The flush controller 120 may transmit the flush command to the storage device 200 through the interface 110 based on the state information of the electronic device 100. The flush controller 120 may identify the state information of the electronic device 100, and transmit the flush command to the storage device 200 based on the state information. In an example embodiment, the flush controller 120 may include at least one of application-specific integrated circuit (ASIC), field-programmable gate array (FPGA), system on chip (SoC) and integrated circuit (IC). However, it is a mere example embodiment. The flush controller 120 may be modified and implemented as a hardware module, such as a logic circuit of various types.

In an example embodiment, the flush controller 120 may include the monitoring part 121 and the operation controller 122. The monitoring part 121 may identify the state information of the electronic device 100, and output a trigger signal according to various state values (or temperature values) included in the state information. In an example embodiment, the monitoring part 121 may be implemented as a circuit including at least one of a multiplexer, a comparator, and a logic gate (for example, AND, OR, NOT, NAND, NOR). The operation controller 122 may output a flush command according to a trigger signal. In an example embodiment, the operation controller 122 may be implemented as a circuit including at least one of a comparator, a logic gate (for example, AND, OR, NOT, NAND, NOR), and a microcontroller.

The storage device 200 may include the memory interface 210, the volatile memory 220, the nonvolatile memory 230 and a memory controller 240. The memory interface 210, the volatile memory 220, the nonvolatile memory 230 and the memory controller 240 may be connected to each other via a bus. The descriptions may be equally applied to the volatile memory 220 and the nonvolatile memory 230.

The memory interface 210 may communicate with the interface 110 of the electronic device 100. In an example embodiment, the memory interface 210 may receive the flush command from the interface 110. In an example embodiment, the memory interface 210 may forward the received flush command to the memory controller 240.

In an example embodiment, each of the interface 110 and the memory interface 210 may include at least one of peripheral component interconnect express (PCIe), I2C, I3C, SMBus, advanced technology attachment (ATA), serial ATA (SATA), parallel ATA (PATA), small computer systems interface (SCSI), serial attached SCSI (SAS), nonvolatile memory express (NVMe), intelligent platform management interface (IPMI), Ethernet, remote direct memory access (RDMA), fiber channel, InfiniBand, coherent accelerator processor interface (CAPI), cache coherent interconnect for accelerators (CCIX), system management (SM) bus, universal serial bus (USB), multi-media card (MMC), enhanced small disk interface (ESDI), and integrated drive electronics (IDE).

The memory controller 240 may control the overall operation of the storage device 200. For example, the memory controller 240 may control the operation of each of the memory interface 210, the volatile memory 220 and the nonvolatile memory 230. The memory controller 240 may manage the data stored in each of the volatile memory 220 and the nonvolatile memory 230. In an example embodiment, the memory controller 240 may include at least one of the ASIC, the FPGA, the SoC and the IC. However, it is a mere example embodiment, and the memory controller 240 may be modified and implemented as a hardware module such as various types of logic circuits.

In an example embodiment, when a flush command is received through the memory interface 210, the memory controller 240 may perform a flush operation by which data stored in the volatile memory 220 is stored in the nonvolatile memory 230. The flush operation may be an operation to save data temporarily stored in the volatile memory 220 in the nonvolatile memory 230.

For example, the memory interface 210 may receive data from the interface 110 of the electronic device 100. The memory controller 240 may temporarily store data received through the memory interface 210 in the volatile memory 220. The memory controller 240 may perform the flush operation when the flush command is received.

In an example embodiment, the memory controller 240 may perform the flush operation when a reference event occurs. For example, the reference event may include an event that the volatile memory 220 receives the flush command from the electronic device 100. In an example embodiment, the reference event may include at least one of an event where data of a size or quantity greater than the reference value is stored and an event that a reference period of time is elapsed.

In an example embodiment, the electronic device 100 may supply power to the storage device 200. The storage device 200 may operate using power supplied from the electronic device 100. In an example embodiment, if the power of the electronic device 100 is unstable, or if the storage device 200 is detached from the electronic device 100, the power supplied to the storage device 200 may be cut off. In this case, the data stored in the volatile memory 220 may be lost. In the present disclosure, the electronic device 100 may minimize data loss of the storage device 200 by transmitting the flush command to the storage device 200 before the power supplied to the storage device 200 is cut off according to the state information.

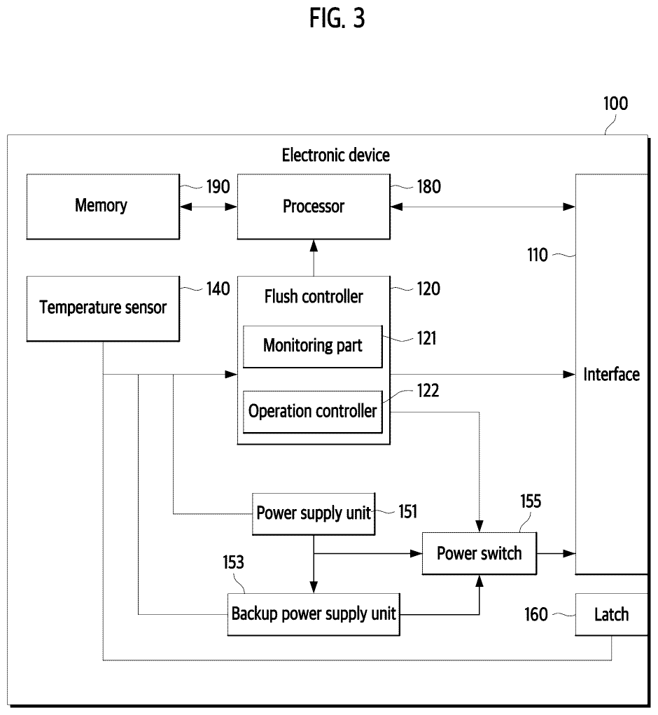

FIG. 3 is a drawing for explaining an electronic device according to an example embodiment.

Referring to FIG. 1 to FIG. 3, the electronic device 100 may include the interface 110 and the flush controller 120. According to an example embodiment, the electronic device 100 may further include at least one of a temperature sensor 140, a power supply unit 151, a backup power supply unit 153, a power switch 155, a latch 160, a processor 180 and a memory 190. In an example embodiment, the interface 110, the flush controller 120, the temperature sensor 140, the power supply unit 151, the backup power supply unit 153, the power switch 155, the latch 160, the processor 180 and the memory 190 may be connected to each other via a bus.

In an example embodiment, the electronic device 100 may further include a printed circuit board. Each of the interface 110, the flush controller 120, the temperature sensor 140, the power supply unit 151, the backup power supply unit 153, the power switch 155, the latch 160, the processor 180 and the memory 190 may be connected to a port (or a slot) on the printed circuit board. For example, the printed circuit board may further include at least one of a main board and a backplane. The backplane may connect multiple hardware modules to each other via a bus.

The temperature sensor 140 may obtain the temperature value inside the electronic device 100. For example, the temperature sensor 140 may periodically obtain and output temperature values. The temperature values may be included in the state information. The temperature sensor 140 may include at least one of a thermistor, which obtains temperature value through a device whose resistance changes according to temperature change, a thermocouple that obtains a temperature value through electromotive force of two different types of metals, and a diode temperature sensor that obtains a temperature value through the characteristic that the voltage drop of the diode changes with temperature. However, it is a mere example embodiment, and the temperature sensor 140 may be modified and implemented with various other types of temperature sensors.

In an example embodiment, the power supply unit 151 may supply power to internal components of the electronic device 100. For example, the power supply unit 151 may supply power to internal components of the electronic device 100 through a printed circuit board or power cable. In an example embodiment, the power supply unit 151 may generate power using external power. In an example embodiment, the power supply unit 151 may include a regulator for converting an input voltage to a constant output voltage and a filter for removing noise. In an example embodiment, the power supply unit 151 may further include a cooling fan for cooling.

In an example embodiment, the power supply unit 151 may supply power to the storage device 200. For example, the power supply unit 151 may supply power to the storage device 200 via the interface 110. In another example embodiment, the power supply unit 151 may supply power to the storage device 200 through a power cable or printed circuit board separate from the interface 110. The storage device 200 may operate using the supplied power.

The backup power supply unit 153 may be charged by the power supply unit 151. In an example embodiment, the power supply unit 151 may supply power to the backup power supply unit 153. In an example embodiment, the power supply unit 151 may simultaneously supply power to the storage device 200 and the backup power supply unit 153. In an example embodiment, the backup power supply unit 153 may include at least one of a battery, a capacitor, and a supercapacitor. However, it is a mere example embodiment, and the backup power supply unit 153 may include various types of energy modules.

The backup power supply unit 153 may supply power to the storage device 200. For example, the backup power supply unit 153 may supply power to the storage device 200 via the interface 110. In another example embodiment, the backup power supply unit 153 may supply power to the storage device 200 through a power cable or printed circuit board separate from the interface 110. In an example embodiment, the backup power supply unit 153 may supply power to the storage device 200 instead of the power supply unit 151. In other words, if there is a problem with the power supply unit 151, the backup power supply unit 153 may supply power as auxiliary power.

The power switch 155 may change the power supplying path of the power supply unit 151 and the backup power supply unit 153. For example, the power switch 155 may include at least one of various switching circuits, such as a relay, a MOSFET and an O-Ring circuit.

Specifically, the power switch 155 may disconnect one of the power supplying paths of the power supply unit 151 and the backup power supply unit 153, and activate the other one.

For example, when a switching command of the first value (for example, 0) is received, the power switch 155 may block the main power supply path between the power supply unit 151 and the interface 110, and activate a backup power supplying path between the backup power supply unit 153 and the interface 110. In this case, the backup power supply unit 153 may supply power to the storage device 200.

In another example embodiment, when a switching command of the second value (for example, 1) is received, the power switch 155 may activate the main power supply path between the power supply unit 151 and the interface 110, and block the backup power supplying path between the backup power supply unit 153 and the interface 110. In this case, the power supply unit 151 may supply power to the storage device 200.

In an example embodiment, the flush controller 120 may control the power switch 155. In other words, the flush controller 120 may change the power supplying path via the power switch 155. For example, the flush controller 120 may transmit a switching command to the power switch 155 to control the switching operation of the power switch 155.

In a specific example embodiment, the monitoring part 121 may output a trigger signal based on the state information of the electronic device 100. For example, if an abnormality in the power supply unit 151 is detected based on the information about the power supply unit 151 included in the state information, the monitoring part 121 may output a first trigger signal. When the first trigger signal is received, the operation controller 122 may output a flush command and output a switching command of the first value to the power switch 155. In another example embodiment, when an abnormality in the backup power supply unit 153 is detected based on the information about the backup power supply unit 153 included in the state information, the monitoring part 121 may output a second trigger signal. When the second trigger signal is received, the operation controller 122 may output a switching command of a second value (for example, 1) to the power switch 155.

However, it is a mere example embodiment, and the entity controlling the power switch 155 may be transformed into the power supply unit 151, the backup power supply unit 153, or the processor 180, when implemented. In a specific example embodiment, the backup power supply unit 153 may determine whether there is an abnormality in voltage or current of power supplied from the power supply unit 151 by comparing a state value indicating the voltage or the current of the power supplied from the power supply unit 151 and a reference value (or a threshold value). When detecting an abnormality in the power suppled from the power supply unit 151, the backup power supply unit 153 may output the switching command of the first value to the power switch 155, and when not detecting an abnormality in the power supplied from the power supply unit 151, the backup power supply unit 153 may output the switching command of the second value to the power switch 155. For example, the backup power supply unit 153 may further include a detection circuit that periodically obtains state values by detecting the level of voltage or current of the power supplied from the power supply unit 151, a comparator that compares the state value with a reference value (or threshold value) and generates an output signal, and a microcontroller that generates a switching signal based on an output signal.

The latch 160 may secure the storage device 200 in the locked state. For example, the latch 160 may be used to secure the connection of the storage device 200 to the interface 110 in the locked state. The latch 160 may detach the storage device 200 in the unlocked state. For example, by the latch 160, in the released state, the storage device 200 may be detached from the interface 110, and the storage device 200 may be removed. For example, in the locked state, the storage device 200 may be attached to the electronic device 100 (more particularly, the interface 110) so that the storage device 200 receives power from the electronic device 100. In the unlocked state, the storage device 200 may be detached from the electronic device 100 (more particularly, the interface 110) so that the power supply to the storage device 200 is cut off from the electronic device 100. In an example embodiment, the latch 160 may be implemented in a variety of ways, including sliding, button, and screw types.

In an example embodiment, the latch 160 may include a main body part for securing the storage device 200, and a contact sensor that detects the locked state and the unlocked state of the latch 160. For example, in the locked state, the contact sensor may output the state information of the latch 160 indicating that the latch 160 is in the locked state by detecting contact with the main body part. In another example embodiment, in the unlocked state, the contact sensor may output the state information of the latch 160 indicating that latch 160 is in the unlocked state, by detecting non-contact of the main body part.

The processor 180 may control the overall operation of the electronic device 100. The processor 180 may execute programs or compute (or process) data. The processor 180 may load data (or programs, etc.) stored in the storage device 200 into the memory 190. The processor 180 may store data stored in the memory 190 in the storage device 200. In an example embodiment, there may be one processor 180 or more. For example, the processor 180 may include at least one of central processing unit (CPU), baseboard management controller (BMC), graphics processing unit (GPU), digital signal processor (DSP), application processing unit (APU), neural network processing unit (NPU), electronic control unit (ECU) and system on chip (SoC).

The memory 190 may store various data or programs inside the electronic device 100. In an example embodiment, the memory 190 may store state information of the electronic device 100. In an example embodiment, the memory 190 may include volatile memory. However, it is a mere example embodiment, and the memory 190 may include at least one of the volatile memory and the nonvolatile memory. For example, the memory 190 may include at least one of DRAM, SRAM, non-volatile dual inline memory module (NVDIMM), high bandwidth memory (HBM) and register. In an example embodiment, the storage speed of the memory 190 may be faster than that of the storage device 200.

In an example embodiment, the monitoring part 121 may identify the state information of the electronic device 100. The monitoring part 121 may output a trigger signal based on the state information of the electronic device 100. For example, as a result of comparing the value included in the state information with the reference value (or the threshold value), the monitoring part 121 may output a trigger signal depending on the state of specific information included in the state information, or whether the state information includes a specific signal.

In an example embodiment, the state information of the electronic device 100 may include a state value representing the voltage or the current of the power supplied from the power supply unit 151. In an example embodiment, the monitoring part 121 may include a detection circuit that periodically detects the voltage or the current of each of multiple nodes on the power supply path of the power supply unit 151. The monitoring part 121 may obtain the state value representing the voltage or the current. In another example embodiment, the power supply unit 151 may include a detection circuit that periodically detects the voltage or the current of each of a plurality of nodes on the power supplying path of the power supply unit 151, and the monitoring part 121 may receive and obtain the state value from the power supply unit 151.

In an example embodiment, the state information of the electronic device 100 may include the remaining life of the backup power supply unit 153. For example, the state information of the electronic device 100 may include the remaining life of the backup power supply unit 153. The remaining life may indicate the maximum capacity that may currently be charged out of the total charge capacity. In an example embodiment, the monitoring part 121 may include a detection circuit that periodically measures the remaining life of the backup power supply unit 153. For example, the monitoring part 121 may measure the internal resistance or leakage current of capacitors included in the backup power supply unit 153, and obtain the remaining life corresponding to the measured value. In another example embodiment, the monitoring part 121 may obtain the remaining life by integrating the current flowing during charging and discharging the battery included in the backup power supply unit 153 with respect to time, or obtain the remaining life corresponding to a measured value by measuring the impedance of the battery. In another example embodiment, the backup power supply unit 153 may include a detection circuit that periodically measures remaining life, and the monitoring part 121 may receive and obtain the remaining life of the backup power supply unit 153 from the backup power supply unit 153.

In an example embodiment, the state information of the electronic device 100 may include a temperature value inside the electronic device 100. In an example embodiment, the monitoring part 121 may receive and obtain the temperature value inside the electronic device 100 from the temperature sensor 140.

In an example embodiment, the state information of the electronic device 100 may include information representing the state of the latch 160. In an example embodiment, the monitoring part 121 may receive and obtain information indicating the state of the latch 160 from the latch 160. Here, the state of the latch 160 may be either the locked state or the unlocked state.

In an example embodiment, when the state of the latch 160 included in the state information changes from the locked state to the unlocked state, the operation controller 122 may transmit a flush command to the storage device 200. For example, the monitoring part 121 may periodically identify the state of the latch 160 included in the state information. When it is identified that the state of the latch 160 is changed from the locked state to the unlocked state, the monitoring part 121 may output a trigger signal. When receiving the trigger signal, the operation controller 122 may transmit the flush command to the storage device 200.

In an example embodiment, the state information of the electronic device 100 may include an alarm signal. In an example embodiment, the monitoring part 121 may receive and obtain the alarm signal from various components (for example, the processor 180 or the power supply unit 151) inside the electronic device 100. The alarm signal may be a signal indicating various warnings or errors. For example, the alarm signal may be a power-off signal that the power to the electronic device 100 is turned off or a power-sleep signal that the power is put to sleep. For example, the alarm signal may be an input/output fail signal indicating that an error occurs in inputting/outputting data. For example, the alarm signal may be a fan fail signal that indicates a cooling fan failure or abnormal state.

In an example embodiment, when the state information includes an alarm signal, the operation controller 122 may transmit a flush command to the storage device 200. For example, the monitoring part 121 may periodically identify whether the state information contains an alarm signal. When it is identified that an alarm signal is included, the monitoring part 121 may output a trigger signal. When receiving the trigger signal, the operation controller 122 may transmit a flush command to the storage device 200.

Meanwhile, according to an example embodiment of the present disclosure, when receiving the trigger signal, the operation controller 122 may transmit a data transfer command to the processor 180 before transmitting a flush command. When the data transfer command is received, the processor 180 may transfer data currently being processed by the processor 180 and/or data stored in the memory 190 to the storage device 200 via the interface 110. The storage device 200 may store the received data in the volatile memory 220. When the data transmission to the storage device 200 completes, the processor 180 may transmit a data transmission completion signal to the operation controller 122. When the data transmission completion signal is received, the operation controller 122 may transmit a flush command to the storage device 200 through the interface 110. According to example embodiments, loss of data inside the electronic device 100 may be minimized.

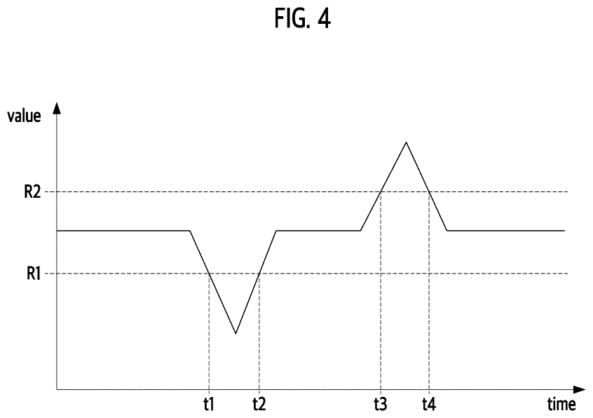

FIG. 4 is a drawing for explaining state information according to an example embodiment.

Referring to FIG. 3 and FIG. 4, the state information of the electronic device 100 may include values representing various states. For example, the state information may include at least one of a state value indicating the voltage or the current of the power supplied from the power supply unit 151, the remaining life of the backup power supply part 153, and a temperature value inside the electronic device 100.

In an example embodiment, the monitoring part 121 may compare a value included in the state information with a reference value. The reference value may include at least one of a lower limit R1 and an upper limit R2 of a reference range. The lower limit R1 may be less than the upper limit R2. For example, the monitoring part 121 may identify whether an event occurs in which a value included in the state information is less than the lower limit R1 or greater than the upper limit R2. In an example embodiment, when the accumulated number of times or the accumulated time that an event occurs is greater than a threshold value, the monitoring part 121 may output a trigger signal.

For example, FIG. 4 illustrates that: during a first period of time between a first time point t1 and a second time point t2, an event occurs once in which the value contained in the state information is less than the lower limit R1 of the reference range; and during a second period of time between a third time point t3 and a fourth time point t4, an event occurs once in which the value contained in the state information is greater than the upper limit R2 of the reference range. In this case, the accumulated number of times that the event occurred is 2, and the accumulated time that the event occurred is the sum of the first period of time and the second period of time.

In an example embodiment, the monitoring part 121 may output a trigger signal when the accumulated number of times that the event occurred is greater than a preset first threshold value, or the accumulated time that the event occurred is greater than a preset second threshold value. In an example embodiment, the monitoring part 121 may output a trigger signal when the accumulated number of times that the event occurred is greater than the preset first threshold value, and the accumulated time that the event occurred is greater than the preset second threshold value.

In a specific example embodiment, the operation controller 122 may transmit a flush command to the storage device 200 according to an event in which the state value representing the voltage or the current of the power supplied from the power supply unit 151 included in the state information is less than the lower limit of the reference range or greater than the upper limit of the reference range. For example, the monitoring part 121 may periodically identify whether an event occurs in which a state value indicating the voltage or the current of the power supplied from the power supply unit 151 included in the state information is less than the lower limit of the reference range or greater than the upper limit of the reference range. The event may include a sudden power off (SPO) event or a voltage drop event. The lower limit and upper limit of the reference range may be preset. For example, the reference range may be set by taking into account the error within the voltage range that is required to perform the operation normally.

Further, the monitoring part 121 may output the first trigger signal when the accumulated number of times that the event occurred is greater than the first threshold value, or the accumulated time that the event occurred is greater than the second threshold value. In another example embodiment, the monitoring part 121 may output the first trigger signal when the accumulated number of times that the event occurred is greater than the first threshold value, and when the accumulated time that the event occurred is greater than the second threshold value. The operation controller 122 may transmit a flush command to the storage device 200 when the first trigger signal is received.

In an example embodiment, the operation controller 122 may control the backup power supply unit 153 to supply power to the storage device 200 instead of the power supply unit 151 in response to the first trigger signal.

In an example embodiment, the operation controller 122 may transmit the flush command to the storage device 200 when the remaining life of the backup power supply unit 153 included in the state information is less than the threshold value required for the flush operation. For example, the monitoring part 121 may periodically identify whether an event occurs in which the remaining life of the backup power supply unit 153 included in the state information is less than the threshold value required for the flush operation. The threshold value required for the flush operation may be a value determined based on the error range based on the amount of energy required to perform the flush operation. When the event occurs, the monitoring part 121 may output a second trigger signal. When the second trigger signal is received, the operation controller 122 may transmit the flush command to the storage device 200.

In an example embodiment, the operation controller 122 may control the power supply unit 151 to supply power to the storage device 200 in response to the second trigger signal. In an example embodiment, when both the first trigger signal and the second trigger signal are received, the operation controller 122 may skip transmitting the flush command, and the operation controller 122 may output an alarm message through a display or speaker connected to the electronic device 100.

In an example embodiment, the operation controller 122 may transmit the flush command to the storage device 200 based on an event in which the temperature value included in the state information is less than the lower limit of the reference range or greater than the upper limit of the reference range. For example, the monitoring part 121 may periodically identify whether an event occurs in which the temperature value included in the state information is less than the lower limit of the reference range or greater than the upper limit of the reference range. The event may be an abnormal temperature event. The lower limit and the upper limit of the reference range may be preset. For example, the reference range may be set based on error within the temperature range required to perform the operation normally.

Further, the monitoring part 121 may output a third trigger signal when the accumulated number of times that the event occurred is greater than the first threshold value, or the accumulated time that the event occurred is greater than the second threshold value. In another example embodiment, the monitoring part 121 may output a third trigger signal when the accumulated number of times that the event occurred is greater than the first threshold value, and when the accumulated time that the event occurred is greater than the second threshold value. When the third trigger signal is received, the operation controller 122 may transmit the flush command to the storage device 200.

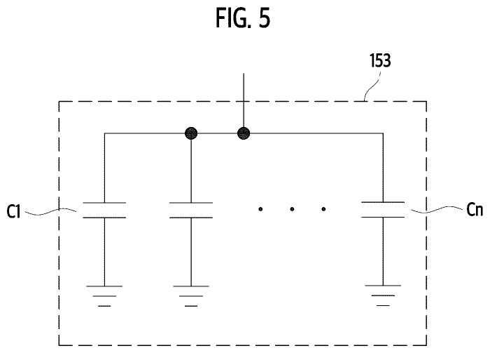

FIG. 5 is a drawing for explaining a backup power supply unit according to an example embodiment.

Referring to FIG. 5, the backup power supply unit 153 may include at least one capacitor (at least one of capacitors C1 to CN). In an example embodiment, the plurality of capacitors (the capacitors C1 to CN) included in the backup power supply unit 153 may be connected in parallel. Each of the capacitors C1 to CN may include at least one of an electrolytic capacitor, a tantalum capacitor, a film capacitor and a ceramic capacitor.

The backup power supply unit 153 may be charged by the power supply unit 151. In this case, the electrical energy stored in the backup power supply unit 153 may be expressed as shown in Equation 1 below.

$$E = \frac{1}{2} {C V}^{2} \qquad [ Equation 1 ]$$

Here, E is the electrical energy stored in the backup power supply unit 153, C is the equivalent capacitance of the backup power supply unit 153, and V is the charging voltage of the backup power supply unit 153. For example, the charging voltage may be the voltage of the power supplied by the power supply unit 151.

Meanwhile, the backup power supply unit 153 may deteriorate depending on the time or the number of uses. For example, the equivalent capacitance C may decrease due to deterioration. Accordingly, the maximum electrical energy E that may be stored in the backup power supply unit 153 may be reduced. According to example embodiments, the flush controller 120 may minimize data loss by controlling the flush operation to be performed or by outputting an alarm message by comparing the remaining life of the backup power supply unit 153 included in the state information with the threshold value required for the flush operation, and outputting a trigger signal.

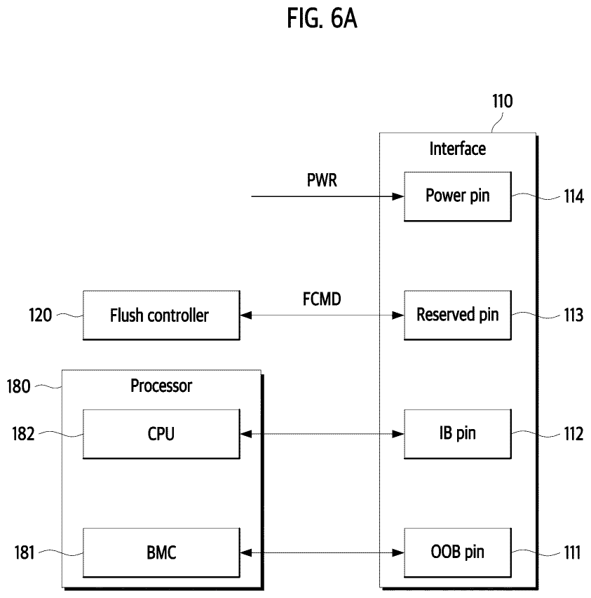

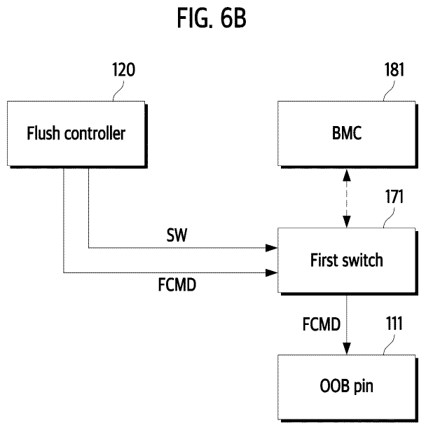

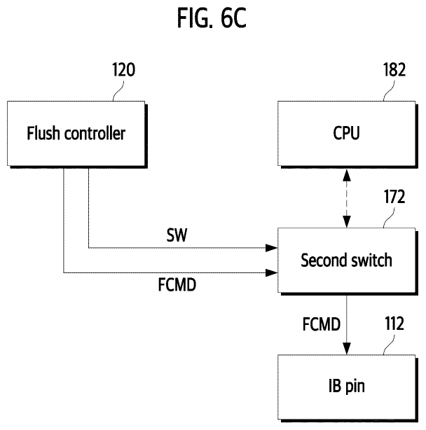

FIG. 6A is a diagram illustrating a flush controller, a processor, and an interface according to an example embodiment. FIG. 6B and FIG. 6C are drawings for explaining a switch according to an example embodiment.

Referring to FIG. 6A to FIG. 6C, the interface 110 may include at least one of an out-of-band (OOB) pin 111, an in-band (IB) pin 112, a reserved pin 113 and a power pin 114. In an example embodiment, the processor 180 may include at least one of a baseboard management controller (BMC) 181 and a CPU 182.

The BMC 181 may communicate with the storage device 200 via the OOB pin 111. For this, the BMC 181 may be connected to the OOB pin 111. The OOB pin 111 may be a pin to manage the storage device 200. In an example embodiment, the BMC 181 may transmit control signals to manage the storage device 200 via the OOB pin 111. For example, the BMC 181 may monitor the state (for example, the temperature, the voltage, or the fan speed) of the storage device 200 or transmit control signals to control operations (for example, the reset or power off) to the storage device 200 via the OOB pin 111, and receive a signal in response to the control signal from the storage device 200. The OOB pin 111 is a pin independent of the IB pin 112. For example, while data is being transmitted or received via the IB pin 112, the OOB pin 111 may transmit the control signal to the storage device 200 or receive the response signal. In an example embodiment, the OOB pin 111 may be a pin for various communication interfaces such as SMBus, I2C, I3C, IPMI, and Ethernet for hardware state monitoring and management.

The CPU 182 may communicate with the storage device 200 via the IB pin 112. For this, the CPU 182 may be connected to the IB pin 112. The CPU 182 may transmit data to or receive data from the storage device 200 via the IB pin 112. The IB pin 112 may be a pin for transmitting data. In an example embodiment, the IB pin 112 may include a data pin for transmitting and receiving data and a clock signal pin for transmitting and receiving a clock signal to synchronize the transmission of data. In an example embodiment, the IB pin 112 may be a pin for various communication interfaces such as SATA, NVMe, and PCIe for high-speed data transmission.

The reserved pin 113 is intended to support future extensions to the standard protocol, and the reserved pin 113 may be an unassigned pin or a pin for debugging.

The power pin 114 may be a pin to supply power PWR. For example, the power pin 114 may deliver the power PWR provided from the power supply unit 151 or the backup power supply unit 153 of the electronic device 100 to the storage device 200.

Referring to FIG. 6A, based on the state information of the electronic device 100, the flush controller 120 may transmit a flush command FCMD to the storage device 200 through the reserved pin 113. For example, the monitoring part 121 of the flush controller 120 may identify the state information of the electronic device 100, and output a trigger signal based on the state information. The operation controller 122 of the flush controller 120 may transmit the flush command FCMD to the reserved pin 113 in response to the trigger signal. The reserved pin 113 may transmit the flush command FCMD to the storage device 200.

Referring to FIG. 6B and FIG. 6C, based on the state information of the electronic device 100, the flush controller 120 may transmit the flush command FCMD to the storage device 200 by interrupting either the OOB pin 111 connected to the BMC 181 or the IB pin 112 connected to the CPU 182.

Referring to FIG. 6B, the electronic device 100 may further include a first switch 171 connected between the OOB pin 111 and the BMC 181. The first switch 171 may be switched to block or activate the transmission path between the BMC 181 and the OOB pin 111 depending on a switching signal SW. In an example embodiment, the first switch 171 may include switching circuits such as O-Ring circuits, multiplexers and relays.

In an example embodiment, based on the state information of the electronic device 100, the flush controller 120 may control the first switch 171 to transmit the flush command FCMD to the storage device 200 through the OOB pin 111. For example, the monitoring part 121 of the flush controller 120 may identify the state information of the electronic device 100, and output a trigger signal based on the state information. The operation controller 122 of the flush controller 120 may transmit the switching signal SW to the first switch 171 in response to the trigger signal. Depending on the switching signal SW, the first switch 171 may block the transmission path between the BMC 181 and the OOB pin 111, and activate the transmission path between the flush controller 120 and the OOB pin 111. The operation controller 122 may transmit the flush command FCMD to the OOB pin 111, and the OOB pin 111 may transmit the flush command FCMD to the storage device 200.

Referring to FIG. 6C, the electronic device 100 may further include a second switch 172 connected between the IB pin 112 and the CPU 182. The second switch 172 may be switched to block or activate the transmission path between the IB pin 112 and the CPU 182 in response to the switching signal SW. In an example embodiment, the second switch 172 may include switching circuits such as O-Ring circuits, multiplexers, and relays.

In an example embodiment, based on the state information of the electronic device 100, the flush controller 120 may control the second switch 172 to transmit the flush command FCMD to the storage device 200 via the IB pin 112. For example, the monitoring part 121 of the flush controller 120 may identify the state information of the electronic device 100, and output a trigger signal based on the state information. The operation controller 122 of the flush controller 120 may transmit the switching signal SW to the second switch 172 in response to the trigger signal. Depending on the switching signal SW, the second switch 172 may block the transmission path between the IB pin 112 and the CPU 182, and activate the transmission path between the flush controller 120 and the IB pin 112. The operation controller 122 may transmit the flush command FCMD to the IB pin 112, and the IB pin 112 may transmit the flush command FCMD to the storage device 200.

Meanwhile, it is described that the flush controller 120 interrupts the BMC 181 or the CPU 182 to transmit the flush command FCMD to the storage device 200 in the above example embodiments, but they are mere example embodiments, and the flush controller 120 may transmit the flush command FCMD to the storage device 200 via the BMC 181 or the CPU 182. Referring to FIG. 3 in which the processor 180 may include the BMC 181 and the CPU 182, the flush controller 120 may identify the state information of the electronic device 100, and output a trigger signal to the BMC 181 based on the state information of the electronic device 100. The BMC 181 may transmit the flush command FCMD to the storage device 200 through the OOB pin 111 in response to the trigger signal. In another example embodiment, the flush controller 120 may identify the state information of the electronic device 100, and output a trigger signal to the CPU 182 based on the state information of the electronic device 100. The CPU 182 may transmit the flush command FCMD to the storage device 200 via the IB pin 112 in response to the trigger signal.

Meanwhile, according to an example embodiment, the operation of the flush controller 120 may be modified to be performed entirely in the BMC 181 or the CPU 182 in implementation. For example, the BMC 181 may identify the state information of the electronic device 100, and transmit the flush command FCMD to the storage device 200 through the OOB pin 111 based on the state information of the electronic device 100. In another example embodiment, the CPU 182 may identify the state information of the electronic device 100, and transmit the flush command FCMD to the storage device 200 via the IB pin 112 based on the state information of the electronic device 100.

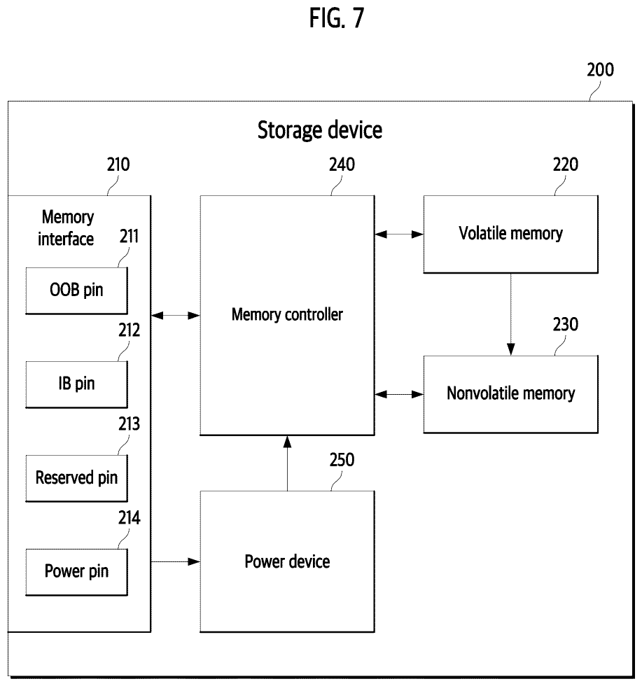

FIG. 7 is a drawing for explaining a storage device according to an example embodiment.

Referring to FIG. 7, the storage device 200 may include the memory interface 210, the volatile memory 220, the nonvolatile memory 230, the memory controller 240 and a power device 250. In an example embodiment, the memory interface 210, the volatile memory 220, the nonvolatile memory 230, the memory controller 240 and the power device 250 may be connected to each other via a bus.

In an example embodiment, the memory interface 210 may include at least one of an OOB pin 211, an IB pin 212, a reserved pin 213 and a power pin 214. The descriptions with regard to the OOB pin 111, the IB pin 112, the reserved pin 113 and the power pin 114 described above may be applied to each of the OOB pin 211, the IB pin 212, the reserved pin 213 and the power pin 214.

For example, the OOB pin 211 of the memory interface 210 may be connected to the OOB 111 of the interface 110 to perform communication for hardware state monitoring and management. The IB pin 212 of the memory interface 210 may be connected to the IB pin 112 of the interface 110, and may perform communication for data transmission. The reserved pin 213 of the memory interface 210 may be connected to the reserved pin 113 of the interface 110 to support future expansion functions. In the present disclosure, the reserved pin 113 may be used for transmitting the flush command FCMD. The power pin 214 of the memory interface 210 is connected to the power pin 114 of the interface 110, so that power may be supplied from the electronic device 100.

In an example embodiment, the memory controller 240 may receive the flush command through the memory interface 210. For example, the memory controller 240 may receive a flush command through one of the OOB pin 211, the IB pin 212, and the reserved pin 213. The memory controller 240 may perform a flush operation to store data stored in the volatile memory 220 into the nonvolatile memory 230 according to the flush command.

The power device 250 may generate operating voltage using externally supplied power.

The power device 250 may provide the operating voltage to the memory controller 240. However, it is a mere example embodiment, and the power device 250 may provide the operating voltage to various components inside the storage device 200. In an example embodiment, the power device 250 may generate the operating voltage to perform a flush operation using power supplied from one of the power supply unit 151 and the backup power supply unit 153 of the electronic device 100. For example, the power device 250 may be powered from either the power supply unit 151 or the backup power supply unit 153 via the power pin 214. The power device 250, when powered, may convert the voltage of the supplied power into the operating voltage having a level necessary to perform the flush operation. For this purpose, the power device 250 may include a regulator and a filter.

According to an example embodiment, the backup power supply unit 153 may not be included in the storage device 200, but may be included in the electronic device 100. In other words, the backup power supply unit may not be mounted on the storage device 200. If the backup power supply unit is mounted separately in the storage device 200, as the number of the storage device 200 connected to the electronic device 100 increases, its efficiency may decrease. According to some example embodiments, while providing a high-capacity storage device 200 with high integration by utilizing the space of the storage device 200 where, if the storage device 200 includes the backup power supply unit 153, the backup power supply unit is installed, data loss of the storage device 200 may be minimized even if various abnormal events occur, such as SPO events and the storage device 200 being separated from or detached from the electronic device.

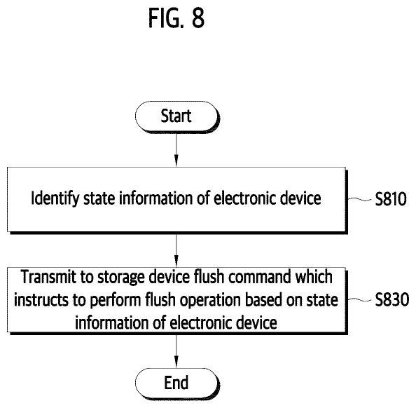

FIG. 8 is a flowchart for explaining a method of operating an electronic device according to an example embodiment.

Referring to FIG. 8, the method of operating the electronic device 100 may include identifying the state information of the electronic device 100 while data is stored in the volatile memory 220 of the storage device 200 in operation S810, and transmitting to the storage device 200 a flush command which instructs to perform a flush operation based on the state information of the electronic device 100 in operation S830. The flush operation may be an operation by which data stored in the volatile memory 220 is stored in the nonvolatile memory 230.

According to an example embodiment, the electronic device 100 may communicate with the storage device 200. In an example embodiment, the electronic device 100 may further include at least one of the temperature sensor 140 for obtaining a temperature value, the power supply unit 151 for supplying power to the storage device 200, the backup power supply unit 153 charged by the power supply unit 151, and the latch 160 for securing the storage device 200.

In an example embodiment, in the method of operating the electronic device 100, the state information of the electronic device 100 may be identified while data is stored in the volatile memory 220 of the storage device 200 in operation S810. For example, in the method of operating the electronic device 100, the state information of the electronic device 100 may be periodically monitored while data is stored in the volatile memory 220 of the storage device 200. For example, the time point for identifying the state information is the time point after the time point that data storage in the volatile memory 220 is completed, and may be the time point at which the volatile memory 220 maintains the stored data. Based on the state information of the electronic device 100, the flush command may be transmitted to the storage device 200 in operation S830. For example, in the method of operating the electronic device 100, the type of information included in the state information of the electronic device 100 may be identified, whether the trigger condition corresponding to the type of information is met may be identified, and depending on the identified result, a flush command may be transmitted to the storage device 200. Here, the state information may include information about at least one of a state value indicating the voltage or the current of the power supplied from the power supply unit 151, the remaining life of the backup power supply part 153, a temperature value inside the electronic device 100, and a state of the latch 160. Each corresponding trigger condition may be preset. Below, specific trigger conditions are described.

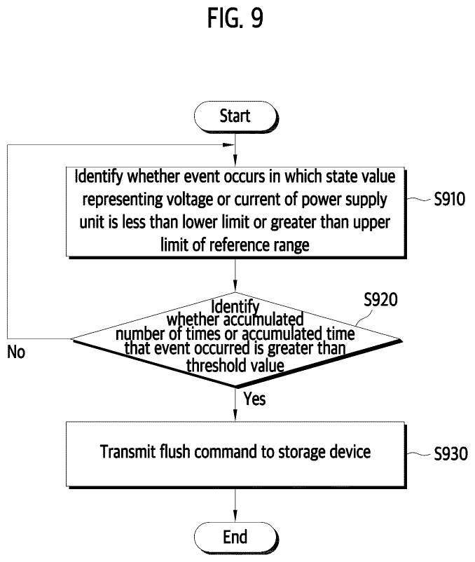

FIG. 9 is a drawing specifically explaining a method of operating an electronic device according to a state value included in state information.

Referring to FIG. 8 and FIG. 9, operation S810 in which the state information of the electronic device 100 is identified may include operation S910 that is identifying whether an event occurs in which the state value representing the voltage or current of the power supplied from the power supply unit 151 included in the state information is less than the lower limit of the reference range or greater than the upper limit of the reference range, and operation S920 that is identifying whether the accumulated number of times or the accumulated time that the event occurred is greater than the threshold value.

In an example embodiment, operation S830 that is transmitting the flush command to the storage device 200 based on the state information of the electronic device 100 may include, when it is identified that the accumulated number of times or the accumulated time that the event occurred is greater than the threshold value (operation S920, Yes), operation S930 that is transmitting the flush command to the storage device 200. Operation S830 that is transmitting the flush command to the storage device 200 based on the state information of the electronic device 100 may include, when it is not identified that the accumulated number of times or the accumulated time that the event occurred is greater than the threshold value, transmitting no flush command to the storage device 200.

In an example embodiment, the method of operating the electronic device 100 may further include the backup power supply unit 153 supplying the power to the storage device 200 instead of the power supply unit 151 when the accumulated number of times or the accumulated time that the event occurred is greater than the threshold value.

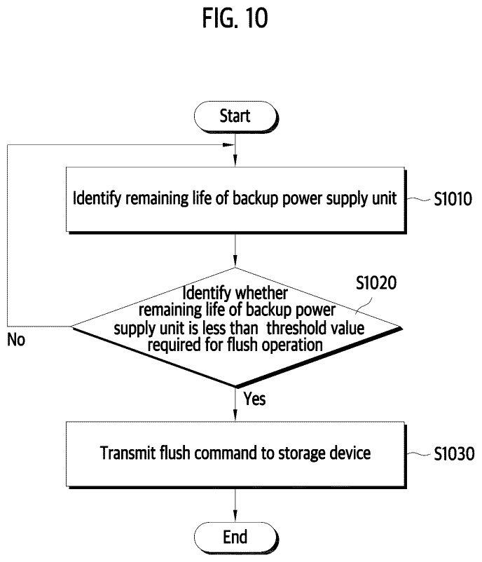

FIG. 10 is a drawing specifically explaining a method of operating an electronic device according to the remaining life included in state information.

Referring to FIG. 8 and FIG. 10, operation S810 that is identifying the state information of the electronic device 100 may include operation S1010 that identifies the remaining life of the backup power supply unit 153. The remaining life may be included in the state information. Operation S810 may further include operation S1020 that identifies whether the remaining life is less than the threshold value required for the flush operation.

In an example embodiment, operation S830 that is transmitting the flush command to the storage device 200 based on the state information of the electronic device 100 may include, when it is identified that the remaining life of the backup power supply unit 153 is less than the threshold value (operation S1020, Yes), transmitting the flush command to the storage device 200 S1030. Operation S830 that is transmitting the flush command to the storage device 200 based on the state information of the electronic device 100 may include, when it is not identified that the remaining life of the backup power supply unit 153 is less than the threshold value (operation S1020, No), transmitting no flush command to the storage device 200.

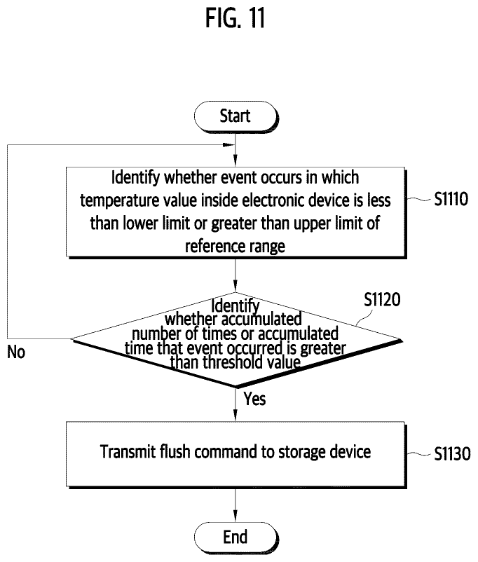

FIG. 11 is a drawing specifically explaining a method of operating an electronic device according to a temperature value included in state information.

In an example embodiment, operation S810 which is identifying the state information of the electronic device 100 may include operation S1110 that is identifying whether an event occurs in which the temperature value inside the electronic device 100 included in the state information is less than the lower limit of the reference range or greater than the upper limit of the reference range, and operation S1120 that is identifying whether the accumulated number of times or the accumulated time that the event occurred is greater than the threshold value.

In an example embodiment, operation S830 that is transmitting the flush command to the storage device 200 based on the state information of the electronic device 100 may include, when it is identified that the accumulated number of times or the accumulated time that the event occurred is greater than the threshold value, operation S1130 that is transmitting the flush command to the storage device 200. Operation S830 that is transmitting the flush command to the storage device 200 based on the state information of the electronic device 100 may include, when it is not identified that the accumulated number of times or the accumulated time that the event occurred is greater than the threshold value (operation S1120, No), transmitting no flush command to the storage device 200.

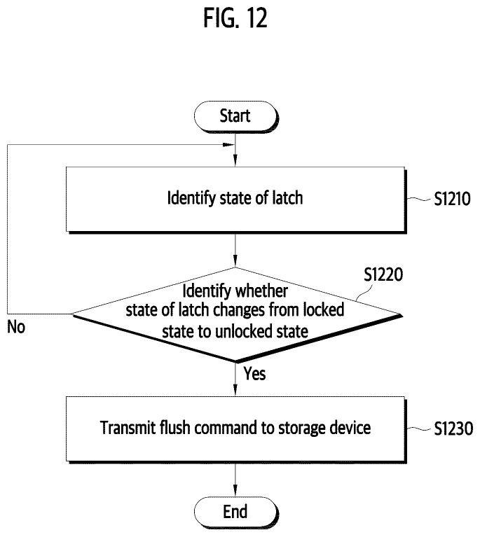

FIG. 12 is a drawing specifically explaining a method of operating an electronic device according to the state of a latch included in state information.

In an example embodiment, operation S810 that is identifying the state information of the electronic device 100 may include operation S1210 that is identifying a state of the latch 160 included in the state information and operation S1220 that is identifying whether the state of the latch 160 changes from the locked state where the storage device 200 is secured to the unlocked state where the storage device 200 is detached.

In an example embodiment, operation S830 that is transmitting the flush command to the storage device 200 based on the state information of the electronic device 100 may include, when it is identified that the state of the latch 160 is changed from the locked state to the unlocked state (operation S1220, Yes), operation S1230 that is transmitting the flush command to the storage device 200. In an example embodiment, operation S830 that is transmitting the flush command to the storage device 200 based on the state information of the electronic device 100 may include, when it is not identified that the state of the latch 160 is changed from the locked state to the unlocked state (operation S1220, No), transmitting no flush command to the storage device 200.

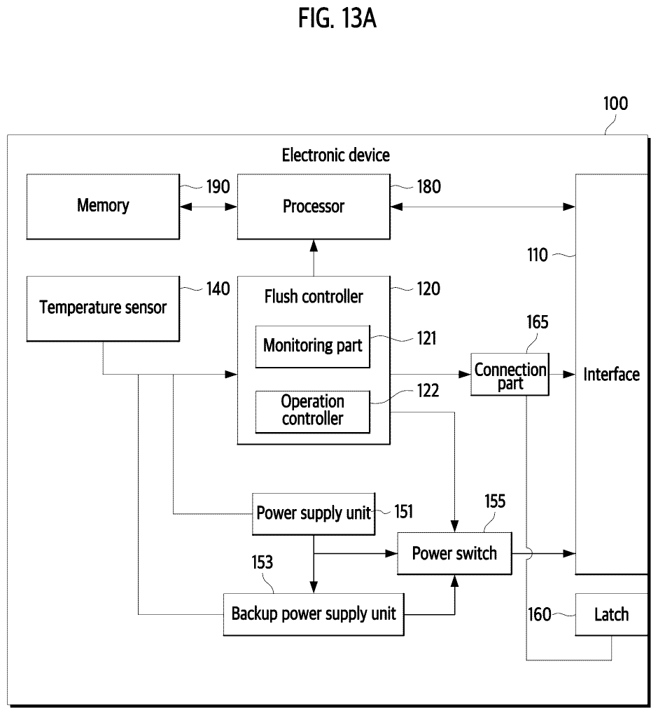

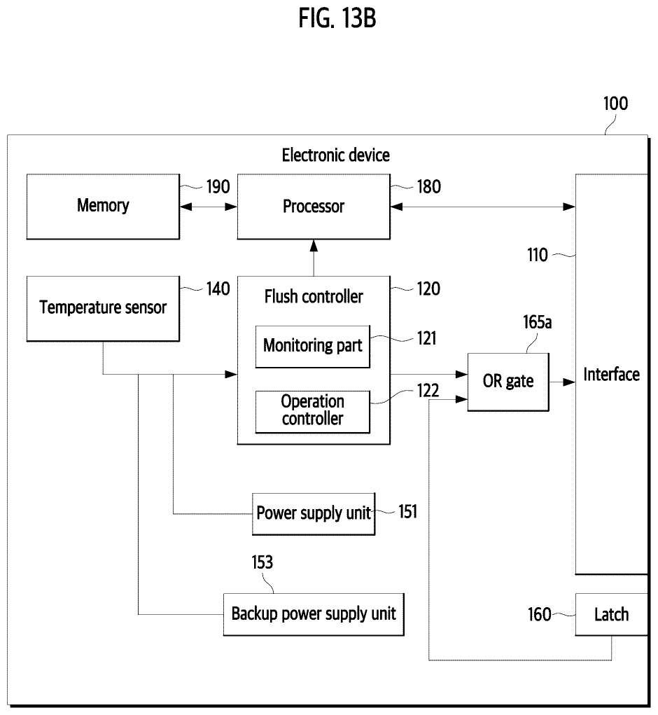

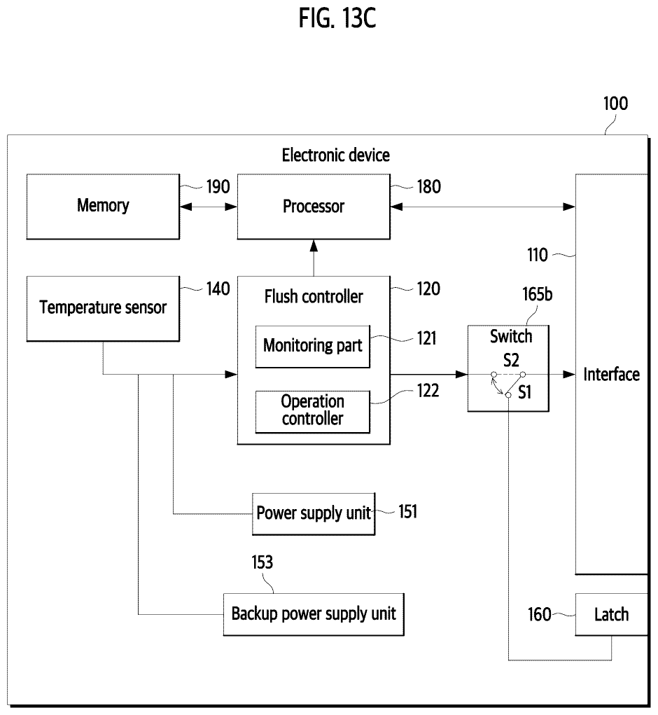

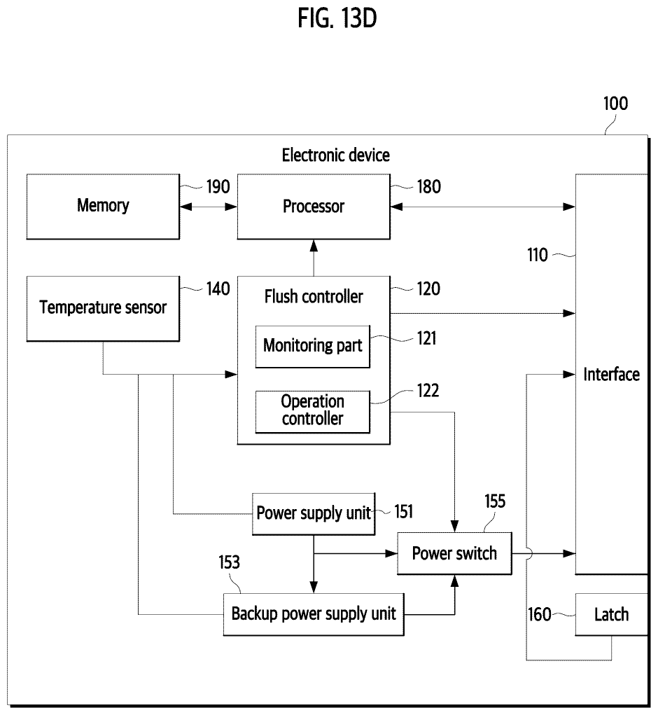

FIGS. 13A to 13D are drawings for explaining an electronic device according to an example embodiment.

Referring to FIG. 13A to FIG. 13C, the electronic device 100 may include the interface 110 transmitting the flush command to the storage device 200, the flush controller 120 including the monitoring part 121 and the operation controller 122, and the latch 160 that outputs an output signal indicating a state change when the state changes from the locked state in which the storage device 200 is attached to the electronic device 100 to the unlocked state in which the storage device 200 is detached from the electronic device 100. Meanwhile, the electronic device 100 may further include at least one of the temperature sensor 140, the power supply unit 151, the backup power supply unit 153, the power switch 155, the latch 160, the processor 180 and the memory 190. The above descriptions may be applied identically to each of the temperature sensor 140, the power supply unit 151, the backup power supply unit 153, the power switch 155, the latch 160, the processor 180 and the memory 190.

According to an example embodiment, the electronic device 100 may further include a connection part 165 (i.e., a connection circuit). The connection part 165 may transmit a flush command to the storage device 200 via the interface 110, depending on the output signals of the operation controller 122 and the latch 160. Specifically, the connection part 165 may be connected to the output terminal of the flush controller 120 and the output terminal of the latch 160. The connection part 165 may receive at least one of the output signal of the flush controller 120 and the output signal of the latch 160. The connection part 165 may transmit the flush command to the storage device 200 through the interface 110 based on at least one of the output signal of the flush controller 120 and the output signal of the latch 160. The output signal of the flush controller 120 may be the trigger signal of the monitoring part 121, or a flush command of the operation controller 122. In an example embodiment, the connection part 165 may be connected to any one of the OOB pin 111, the IB pin 112, or the reserved pin 113 included in the interface 110. For example, referring to FIG. 13A to FIG. 13C, the flush controller 120 and the latch 160 may overlap in part in the transmission path of the flush command to the storage device 200.

Referring to FIG. 13A and FIG. 13B, the connection part 165 may include an OR gate 165a. The OR gate 165a may be connected to the flush controller 120, the latch 160 and the interface 110.

The OR gate 165a may receive at least one of the output signal of the flush controller 120 and the output signal of the latch 160 as an input signal. In an example embodiment, each of the output signal of the flush controller 120 and the output signal of the latch 160 may have one of the first state and the second state. In an example embodiment, a first state may be a low state and the second state may be a high state. In another example embodiment, the first state may be a high state and the second state may be a low state.

For example, the first state of the output signal of the flush controller 120 may indicate that the state information satisfies the trigger condition, and the second state of the output signal of the flush controller 120 may indicate that the state information does not meet the trigger condition. For example, the first state of the output signal of the latch 160 may indicate a state change in which the state of the latch 160 changes from the locked state to the unlocked state, and the second state of the output signal of the latch 160 may indicate that the state of the latch 160 is maintained in the locked state or the unlocked state.

The OR gate 165a may output the output signal of the first state when at least one of the output signal of the flush controller 120 and the output signal of the latch 160 is in the first state. In an example embodiment, the output signal of the first state may be a flush command. In another example embodiment, the output signal of the first state may be a signal that controls the interface 110 to transmit a flush command. When the output signal of the first state is received, the interface 110 may transmit the flush command to the storage device 200. When the flush command is received, the storage device 200 may perform a flush operation by which the data stored in the volatile memory 220 is saved in the nonvolatile memory 230.

The OR gate 165a may output the output signal of the second state when both the output signal of the flush controller 120 and the output signal of the latch 160 are in the second state. When the output signal of the second state is received, the interface 110 may transmit no flush command to the storage device 200.

Referring to FIG. 13A and FIG. 13C, the connection part 165 may include a switch 165b. The switch 165b may be switched to activate either a first path S1 between the interface 110 and the latch 160, or a second path S2 between the flush controller 120 and the interface 110.

For example, when the first path S1 is activated, the output signal of the latch 160 may be transmitted to the interface 110. When the second path S2 is deactivated, the output signal of the flush controller 120 may be blocked from being transmitted to the interface 110. In another example embodiment, when the first path S1 is deactivated, the output signal of the latch 160 may be blocked from being transmitted to the interface 110. When the second path S2 is activated, the output signal of the flush controller 120 may be transmitted to the interface 110.

In an example embodiment, in the default mode, the switch 165b may activate the first path S1, and deactivate the second path S2. In this case, in response to the switching signal, the switch 165b may deactivate the first path S1 and activate the second path S2. After then, in response to another switching signal, the switch 165b may be reverted to the default mode. In other words, the switch 165b may activate the first path S1 and deactivate the second path S2. In another example embodiment, when a preset period of time is elapsed, the switch 165b may be reverted to the default mode.

In another example embodiment, in the default mode, the switch 165b may activate the second path S2, and deactivate the first path S1. In this case, in response to the switching signal, the switch 165b may deactivate the second path S2, and activate the first path S1. After then, in response to another switching signal, the switch 165b may be reverted to the default mode. In other words, the switch 165b may activate the second path S2, and deactivate the first path S1. In another example embodiment, when a preset period of time is elapsed, the switch 165b may be reverted to the default mode.

In an example embodiment, the switching signal that activates the first path S1 may be the output signal of the first state of the flush controller 120, and the switching signal that activates the second path S2 may be an output signal of the second state of the flush controller 120.

In an example embodiment, in the state where the first path S1 is activated, the output signal of the first state of the latch 160 may be transmitted to the interface 110. In an example embodiment, the output signal of the first state may be a flush command. In another example embodiment, the output signal of the first state may be a signal that controls the interface 110 to transmit a flush command. When the output signal of the first state is received, the interface 110 may transmit the flush command to the storage device 200. When the flush command is received, the storage device 200 may perform a flush operation.

Meanwhile, in the state where the first path S1 is activated, the output signal of the second state of the latch 160 may be transmitted to the interface 110. When the output signal of the second state is received, the interface 110 may transmit no flush command to the storage device 200.

In an example embodiment, in the state where the second path S2 is activated, the output signal of the first state of the flash controller 120 may be transmitted to the interface 110. When the output signal of the first state is received, the interface 110 may transmit the flush command to the storage device 200. When the flush command is received, the storage device 200 may perform a flush operation.

Meanwhile, in an example embodiment, in the state where the second path S2 is activated, the output signal of the second state of the flash controller 120 may be transmitted to the interface 110. When the output signal of the second state is received, the interface 110 may transmit no flush command to the storage device 200.

Referring to FIG. 13D, the flush controller 120 and the latch 160 may transmit the flush command through independent transmission paths.

In an example embodiment, the output signal of the flush controller 120 may be transmitted to a pin connected to the flush controller 120 among multiple pins included in the interface 110, and the output signal of the latch 160 may be transmitted to a pin connected to the latch 160 among multiple pins included in the interface 110.

In an example embodiment, the interface 110 may include the OOB pin 111, the IB pin 112 and the reserved pin 113. For example, the flush controller 120 may be connected to one of the OOB pin 111, the IB pin 112, and the reserved pin 113 included in the interface 110. The latch 160 may be connected to any other one of the OOB pin 111, the IB pin 112, and the reserved pin 113 included in the interface 110. In another example embodiment, there may be a plurality of reserved pins 113. The reserved pins 113 may include a first reserved pin and a second reserved pin. In this case, the flush controller 120 may be connected to the first reserved pin, and the latch 160 may be connected to the second reserved pin. Meanwhile, the number of the reserved pins 113 may vary in implementation.

According to example embodiments of the present disclosure, when the state of the latch 160 changes from the locked state to the unlocked state, the signal indicating the state change of the latch 160 may be transmitted to the storage device 200 more quickly. Accordingly, the time at which the storage device 200 starts the flush operation may be brought forward more quickly.

Methods implemented as software modules or algorithms are computer readable codes or program instructions executable on the processor according to the example embodiments, and may be stored on a computer-readable recording medium. Here, the computer-readable recording medium includes a magnetic storage medium (for example, a read-only memory (ROM), a random-access memory (RAM), a floppy disk and a hard disk) and an optically readable medium (for example, a CD-ROM, a digital versatile disc (DVD)). The computer-readable recording medium may be distributed among network-connected computer systems, so that a computer-readable code may be stored and executed in a distributed manner. The medium may be readable by a computer, stored in a memory, and executed on a processor.

The example embodiments may be represented by functional block elements and various processing steps. The functional blocks may be implemented in any number of hardware and/or software configurations that perform specific functions. For example, an example embodiment may adopt integrated circuit configurations, such as memory, processing, logic and/or look-up table, that may execute various functions by the control of one or more microprocessors or other control devices. Similar to that elements may be implemented as software programming or software elements, the example embodiments may be implemented in a programming or scripting language such as C, C++, Java, assembler, etc., including various algorithms implemented as a combination of data structures, processes, routines, or other programming constructs. Functional aspects may be implemented in an algorithm running on one or more processors. Functional aspects may be implemented in an algorithm running on one or more processors. Further, the example embodiments may adopt the existing art for electronic environment setting, signal processing, and/or data processing. Terms such as “mechanism,” “element,” “means” and “configuration” may be used broadly and are not limited to mechanical and physical elements. The terms may include the meaning of a series of routines of software in association with a processor or the like.

The above-described example embodiments are merely examples, and other embodiments may be implemented within the scope of the claims to be described later.

What is claimed is:

1. An electronic device of communicating with a storage device comprising a volatile memory and a nonvolatile memory, the electronic device comprising:
a monitoring circuit configured to identify state information of the electronic device while data is stored in the volatile memory; and
an operation controller configured to transmit to the storage device a flush command instructing to perform a flush operation by which the data stored in the volatile memory is stored in the nonvolatile memory based on the state information of the electronic device.

2. The electronic device of claim 1,
wherein the monitoring circuit is configured to output a trigger signal according to a result of identifying the state information, and
wherein the operation controller is configured to transmit the flush command to the storage device in response to the trigger signal being received from the monitoring circuit.

3. The electronic device of claim 2, further comprising:
a power supply unit configured to supply first power to the storage device; and
a backup power supply unit configured to be charged by the power supply unit.

4. The electronic device of claim 3,
wherein the monitoring circuit is configured to output the trigger signal when an accumulated number of times or an accumulated time that an event occurs is greater than a threshold value,
wherein the event is represented by a state value indicating a voltage or a current of the first power of the power supply unit is less than a lower limit of a reference range or greater than an upper limit of the reference range, and
wherein the state value is included in the state information.

5. The electronic device of claim 4,
wherein the operation controller is configured to control the backup power supply unit to supply second power to the storage device instead of the power supply unit in response to the trigger signal.

6. The electronic device of claim 3,
wherein the monitoring circuit is configured to output the trigger signal when remaining life of the backup power supply unit is less than a threshold value required for the flush operation, and
wherein the remaining life of the backup power supply unit is included in the state information.

7. The electronic device of claim 2, further comprising:
a temperature sensor configured to obtain a temperature value inside the electronic device,
wherein the temperature value is included in the state information, and
wherein the monitoring circuit is configured to output the trigger signal according to an event that the temperature value is less than a lower limit of a reference range or greater than an upper limit of the reference range.

8. The electronic device of claim 2, further comprising:
a latch configured to secure the storage device in a locked state, and detach the storage device from the electronic device in an unlocked state,
wherein, in the locked state, the storage device is attached to the electronic device, and
wherein the monitoring circuit is configured to output the trigger signal when a state of the latch included in the state information is changed from the locked state to the unlocked state.

9. The electronic device of claim 2,
wherein the monitoring circuit is configured to output the trigger signal when identifying an alarm signal from the state information.

10. The electronic device of claim 2, further comprising:
an interface configured to transmit the flush command to the storage device;
a latch configured to output an output signal indicating a state change when a state of the storage device is changed from a locked state in which the storage device is attached to the electronic device to an unlocked state in which the storage device is detached from the electronic device; and
a connection circuit configured to transmit the flush command to the storage device through the interface in response to the output signal of the latch.

11. The electronic device of claim 1, further comprising:
an interface comprising an in-ban (IB) pin configured to transmit the data to the storage device, and an out-of-band (OOB) pin configured to transmit a control signal for managing the storage device;
a baseboard management controller (BMC) configured to communicate with the storage device through the OOB pin for managing the storage device; and
a switch connected between the OOB pin and the BMC,
wherein the operation controller is configured to control the switch and transmit the flush command to the storage device through the OOB pin.

12. A method of operating an electronic device that communicates with a storage device comprising a volatile memory and a nonvolatile memory, the method comprising:
identifying state information of the electronic device while data is stored in the volatile memory; and
transmitting to the storage device a flush command instructing to perform a flush operation by which the data stored in the volatile memory is stored in the nonvolatile memory based on the state information of the electronic device.

13. The method of operating the electronic device of claim 12,
wherein the state information comprises at least one of:
a state value indicating voltage or current of a power supply unit that supplies power to the storage device;
remaining life of a backup power supply unit that is charged by the power supply unit;
a temperature value inside the electronic device; and
a state of a latch configured to attach the storage device to the electronic device or detach the storage device from the electronic device.

14. The method of operating the electronic device of claim 13,
wherein the identifying of the state information of the electronic device comprises:
identifying whether an event occurs that the state value included in the state information is less than a lower limit of a reference range or greater than an upper limit of the reference range; and
identifying whether an accumulated number of times or an accumulated time that the event occurs is greater than a threshold value, and
wherein the transmitting of the flush command to the storage device comprises, when it is identified that the accumulated number of times or the accumulated time that the event occurs is greater than the threshold value, transmitting the flush command to the storage device.

15. The method of operating the electronic device of claim 14, further comprising:
supplying power by the backup power supply unit instead of the power supply unit in response to the accumulated number of times or the accumulated time being greater than the threshold value.

16. The method of operating the electronic device of claim 13,
wherein the identifying of the state information of the electronic device comprises identifying whether the remaining life of the backup power supply unit included in the state information is less than a threshold value required for the flush operation, and
wherein the transmitting of the flush command to the storage device comprises, when it is identified that the remaining life of the backup power supply unit is less than the threshold value, transmitting the flush command to the storage device.

17. The method of operating the electronic device of claim 13,
wherein the identifying of the state information of the electronic device comprises:
identifying whether an event occurs that the temperature value inside the electronic device included in the state information is less than a lower limit of a reference range or greater than an upper limit of the reference range; and
identifying whether an accumulated number of times or an accumulated time that the event occurs is greater than a threshold value, and
wherein the transmitting of the flush command to the storage device comprises, when it is identified that the accumulated number of times or the accumulated time that the event occurs is greater than the threshold value, transmitting the flush command to the storage device.

18. The method of operating the electronic device of claim 13,
wherein the identifying of the state information of the electronic device comprises identifying whether the state of the latch included in the state information changes from a locked state in which the storage device is attached to the electronic device to an unlocked state in which the storage device is detached from the electronic device, and
wherein the transmitting of the flush command to the storage device comprises, when it is identified that the state is changed from the locked state to the unlocked state, transmitting the flush command to the storage device.

19. An electronic system comprising:
a storage device comprising a volatile memory, a nonvolatile memory, and a memory interface; and
an electronic device that comprises:
an interface configured to communicate with the memory interface; and
a flush controller configured to identify state information of the electronic device while data is stored in the volatile memory, and based on the state information, transmit a flush command to the storage device through the interface,
wherein the storage device further comprises a memory controller configured to perform a flush operation by which the data stored in the volatile memory is stored in the nonvolatile memory in response to the flush command received through the memory interface.

20. The electronic system of claim 19,
wherein the electronic device further comprises:
a power supply unit configured to generate first power; and
a backup power supply unit configured to be charged by the power supply unit and generate second power, and
wherein the storage device further comprises a power device configured to generate an operating voltage for performing the flush operation using one of the first power supplied from the power supply unit and the second power supplied from the backup power supply unit.
